(19) United States
(12) Patent Application Publication
(10) Pub. No.: US 2004/0051295 A1
(43) Pub. Date: Mar. 18, 2004

(54) System and method of publishing

(75) Inventors: Benjamin Gross, Tarrytown, NY (US); Diane Gross, Tarrytown, NY (US)

Correspondence Address: Randolph P. Calhoune, Esq., Ohlandt, Greeley, Ruggiero & Perle, L.L.P., One Landmark Square,10th Floor, Stamford, CT, 06901-2682, US

(73) Assignee: Everyday Press, Inc.

(21) Appl. No.: 10/608,777

(22) Filed: Jun. 27, 2003

Related U.S. Application Data
(60) Provisional application No. 60/392,579, filed on Jun. 28, 2002.

(51) Int. Cl. B42D 1/00

(52) U.S. Cl. 281/15.1

(57) ABSTRACT

A system and method for the publication of a fully personalized and completely customized story is provided. The system and method include providing a blank label, a blank board book, and a base software program or module using a general purpose computer for accepting completely variable creative content and controlling the printing of the content to the blank labels.

### BACKGROUND OF THE INVENTION

1. Field of the Invention

The present invention relates to a system and method for publishing books. More particularly, the present invention relates to system and method of self-publishing a board book.

2. Description of the Related Art

Known publishing products and systems do not fully meet the creative needs of a user seeking to create (i.e., publish) works having completely personalized and variable content. Some of the known publication systems and methods have significant creative limitations such as, for example, only providing annotations to photographs in an album, and only providing a method of inserting personalized or variable textual content at specific locations of pre-printed text. For example, there is a prior art publishing system that provides a book by the manufacturer having a limited number of blank spaces on certain individual pages thereof where text printed on labels may be affixed. The printed labels may include textual content such as proper names (e.g., Johnny or Mary), nicknames, and relationships (e.g., Nana or Grandma), and team names (e.g., Pirates and Yankees).

Also, there exist a method for making a children's storybook including a child's personal information entered into a predetermined story, or using transparent stickers with personal data that are then adhered to blank spaces in a preprinted book (U.S. Pat. No. 5,524,932 to Kalisher). The subject matter of the predetermined story is static and the degree of personalization possible is limited. Thus, the resulting book may not be very personal to the child whose name is provided and incorporated into the story.

In some of the known systems and methods, personal information is forwarded to a third party (e.g., a publishing company) that incorporates the personal information, albeit in a limited fashion, into the book. The book produced by this type of system and method is not published by the user and has the disadvantage of being costly and time consuming to complete, as well as the risk of being destroyed and damaged in transit between the manufacturer and the user. Additionally, creative control of the book, including format, types of content, length of content, and other aspects of the creative inputs to the book may be limited by the third party publisher.

Therefore, there exists a need to provide a method and system of publishing a book having completely personalized and variable content using the resources of a typical home or small office environment.

### SUMMARY OF THE INVENTION

It is an object of the present invention to provide a publishing system and method that accepts creative placement of creative content including, for example, drawings, photos, and clip-art.

It is another object of the present invention to provide such a system and method that provides for the publication of a completely original story by providing a plurality of blank labels, a blank book, and a base software program or module for accepting variable content and controlling the printing of the content to the plurality of blank labels so a story can be fully personalized and published under the complete control of the user, preferably in a local environment, preferably using a general purpose computer, printer, and common software.

The above and other objects, advantages, and benefits of the present invention will be understood by reference to following detailed description and appended sheets of drawings.

### BRIEF DESCRIPTION OF THE DRAWINGS

FIG. 1 is an exemplary depiction of a board book made in accordance with the present invention;

FIG. 2 is an overall schematic diagram of an exemplary system applicable for implementing the system and method in accordance with the present invention;

FIG. 3 shows a plan view of an exemplary printed sticker sheet in accordance with the present invention; and

FIG. 4 is a flowchart depicting an exemplary method of publishing a creative work in accordance with the present invention.

### DETAILED DESCRIPTION OF THE INVENTION

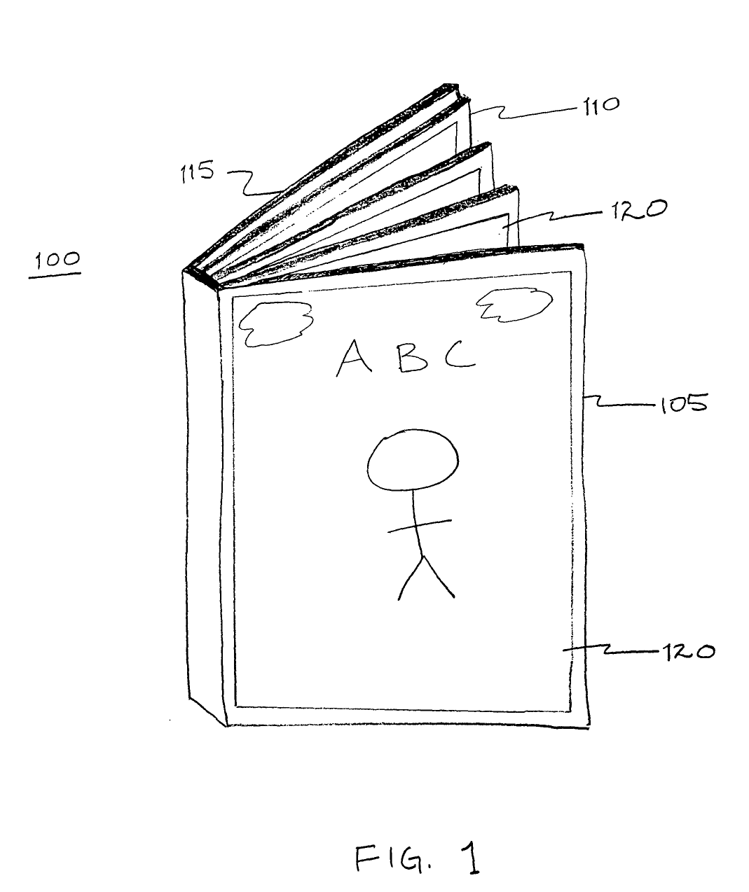

Referring to the drawings and in particular FIG. 1, there is depicted an example of a type of book generally represented by reference numeral 100 that may be created, that is, published by the system and method of the present invention. It is contemplated that the present invention will appeal to a wide variety of people interested in publishing books and other creative works, including young children, the parents of young children, schools and educational programs including literacy programs, remedial reading programs, and tutorial servies.

The present invention will be discussed primarily in the context of a children's board book such as book 100. Accordingly, exemplary embodiment board book 100 is used as an illustrative example for discussing certain aspects of the present invention in a concise and clear manner, not as a limitation thereof. It should be understood that the particular type of medium used may be varied depending on the application and intended use of the published product. For example, the methods and system of the present invention may include a mixed media presentation application such as, though not limited to, a “book” presenting fixed content (e.g., static text and illustrations) and a combination of animated text (e.g., scrolling text), graphics (e.g., multiple photos/illustrations that are sequentially presented to the reader and/or motion video clips) and sound.

Board book 100 may have pressed cardboard front cover 105, pages 110, and rear cover 115. The pages of board book 100 may be of about 14 millimeters (mils) thick. Other thicknesses of material may be used. However, the front cover 105, pages 110, and rear cover 115 of board book 100 are preferably relatively stiff and resistant to being ripped by a young child, as well as being durable to withstand repeated readings since the instance book 100 is intended for young children.

In the instance where the book includes the capability of presenting sound, video, and a combination thereof, the book would have suitable storage and display capabilities for storing these types of creative inputs. For example, a memory storage unit (e.g., flash card, memory stick, smart card, etc.) may be connected to and integrated to the book. A voice synthesis module and or speaker may be included in the instance the user's voiced comments and other sounds are to be played back (i.e., presented) by the book. A display mechanism, such as a LCD or plasma screen may be included for the display of video and graphics type creative input.

Personalized and completely customized graphic and textual creative content may be affixed to front cover 105, pages 110, and rear cover 115 by attaching labels 120 thereto. Labels 120 are produced and fully customized by the user. The user preferably has complete creative freedom in determining the content, format, arrangement, color, and size of the creative content placed on label 120.

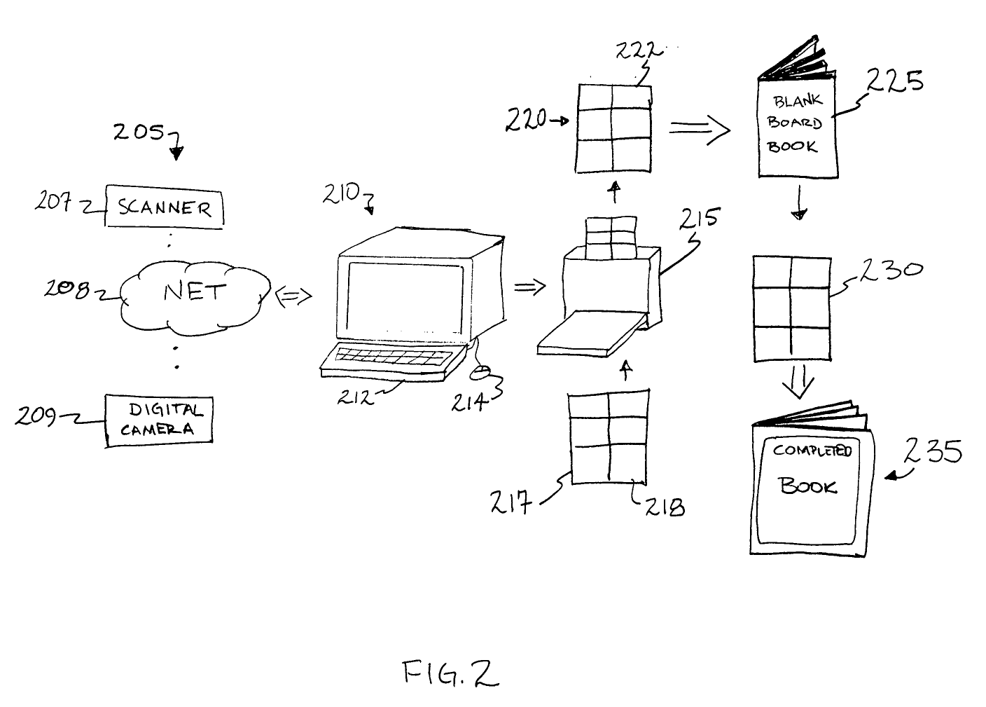

In an aspect of the present invention and in reference to FIG. 2, completely personal and customized book 100 can be created using a PC (personal computer) 210, a printer 215, and software (not shown) such as the home and small office environment. FIG. 2 depicts an exemplary process of creating and assembling, i.e., publishing a completed board book 235 in accordance with the teachings of the present invention. It is noted that published board book 235 is similar to board book 100 of FIG. 1.

It should be appreciated that the particular configuration of the pc, printer, software, and other input, output, and processing devices and controls may vary. In one aspect of the present invention, the particular arrangement and type of input and output controls and devices (hardware and software) used to implement the method and system of the present invention are under the control of the user. In this manner, the user can maintain control of the creative process of creating the book.

The software may be a word processor, a graphics program, an editor, etc., or a combination thereof. It should be appreciated by those skilled in the art that many word processors, graphics programs, web publication programs, internet browsers, and even operating systems include an interface with programs that can manipulate (i.e., create, edit, store, etc.) text and graphics. Thus, the software program or module used in carrying out the present invention need not be specifically designed or created for use by the present invention.

A story for inclusion in book 235 is created by providing personal content for inclusion in the published work via an input device interfaced with PC 210. The input device may include keyboard 212, mouse 214, and any of the input sources 205. Input sources 205 may include a scanner 207, a World Wide Web {i.e., Web} page, a hypertext link, page or content, a digital camera file, or a memory storage medium having the personal content stored therein. Other input sources, though not shown, are applicable such as, for example, a memory card reader, a hard disk drive, a digitizer, and other file storage and creation devices and means.

The present invention allows the user (i.e., the bookmaker) to use any combination of text and images including photographs (from a digital camera or scanner), clip art and drawings (created in software or imported from the internet). The software may be used to provide a template of a label 218. Any combination of text, photographs, pictures, clip art and drawings can be put on the label.

A monitor connected to PC 210 can be used to aid in composing the creative content for each page of book 100. Creative content is preferably manipulated by computer 210 according to program instructions of the software program or module to print the creative content onto a label sheet 217. The program instructions may be implemented as software accessible to PC 210, whether locally or remotely stored.

Label sheet 217 is fed to printer 215. Label sheet 217 is preferably a commercially available product easily and readily handled by printer 215. Preferably, extensive formatting is not required on the user's behalf in order to format the creative content to correspond to label sheet 217. Each label 218 including label sheet 217 preferably represents a page in book 100. Label 218 may comprise only a portion of a page or extend beyond the boundaries of more than one page.

Once the bookmaker/publisher (i.e., user) is satisfied with the composition of the personal creative content of each page of book 100, the pages of the book are printed on blank label sheet 217 having a plurality of blank labels 218, thereby creating a printed label sheet 220 having a plurality of printed labels 222 (similar to printed label 120 of FIG. 1). Multiple labels sheets 217 may be used to create book 225.

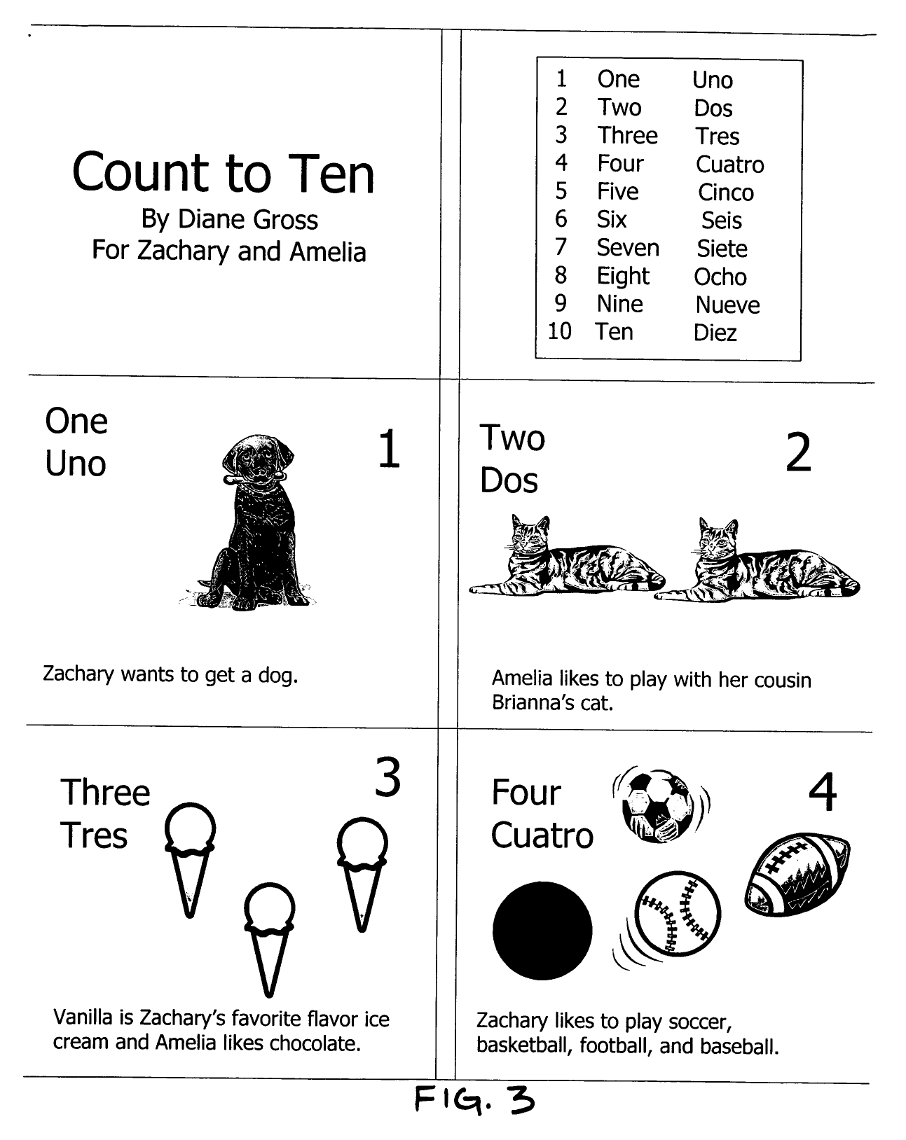

FIG. 3 depicts an exemplary printed label sheet 220.

In one aspect of the present invention, label sheet 217 includes adhesive-backed labels 218. The label sheet 217 preferably contains labels 218 that are suitable for a (color) ink jet printer and a laser jet printer. Printed labels 222 are affixed to the pages of the blank board book 225 by the user. Depending on the size of blank board book 225 and printed labels 222, one printed label covers at least a portion of a page of the blank board book. In a preferred embodiment, one printed label 222 covers substantially one page of blank board book 225.

A self-adhesive clear laminate 230 may be applied over the printed labels 222, that is, the individual pages of the board book 225 to protect and enhance the durability of the pages of the book. Preferably, a clear laminate 230 is applied to printed labels 222 after the printed labels are affixed to the pages of the board book.

In the event that the printer employs an ink resistant to degradation due to exposure to moisture and light, the step of applying the laminate 230 may be precluded.

Covering the printed labels 222 with clear laminate 230 allows for easy cleaning of book 235 (and 100) with a damp cloth without distortion of the printed labels 222 or damage of book 235. Each page has a thickness of about 12 mils to about 18 mils. The paper core (about 8 mils thick) is preferably coated with a film laminate of about 3 mils on each side, resulting in an overall page thickness of about 14 mils. Printed labels 222 can be applied to both sides of a page.

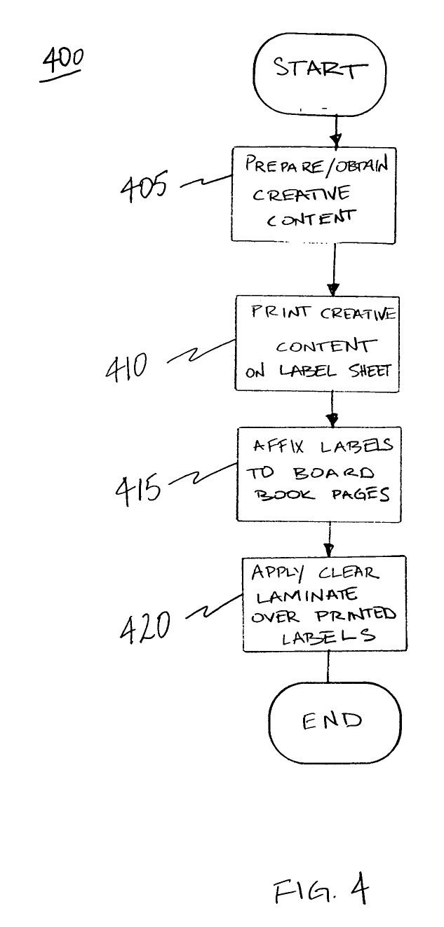

FIG. 4 is a flowchart depicting an exemplary method of publishing a creative work in accordance with the present invention, various steps of which should be appreciated in view of the discussion above regarding the publication of books 100 and 235. As shown, creative content for the creative work (e.g., book 100, 235) is prepared and obtained in step 405. The creative content is then printed to labels 218 at step 410. The printed labels 222 are affixed to the pages of a blank board book at step 415 and clear laminate 230 is applied over the printed labels 222 at step 420 to complete the publishing process.

In summary, it is noted that the present invention may be used to publish a children's storybook, a cookbook, a party favor, and to memorialize vacation memories and other events.

The bookmaker may start with a tabla rosa, i.e., a multiple paged bound board book 225 of approximately 12 pages. Each page being approximately 4 inches×5 inches and a sheet 217 of 6 blank labels 218. The self-adhesive labels 218 are preferably affixed to an 8½ by 11 inch carrier sheet. Each label 218 corresponds to a page, and 2 carrier sheet of 6 labels 2218 would preferably be used to comprise a book 100, 235. Since each page and label is initially completely blank, it allows complete freedom to integrate photographs, line art, clip art and text. Multiple copies of the same book can easily be made from images stored, for example in a hard disk drive, of PC 210. Thus, second editions, new, and revised editions may also be produced.

Board books 100, 235 are a preferred media for children and parents since the pages are specially laminated and therefore very durable and cleanable. Compatible matching label stock provides a durable book. A self-adhesive clear laminate affixed over the printed label 222 further protects the printed label from smudges that may result from a lot of use. A protective covering comprising the laminate may be sprayed and/or brushed onto the pages of the book over printed label 222.

Accordingly, the present invention allows children, parents and teachers to publish “readers” (using either the phonics method or the whole word method), alphabet books, etc. for home and school use.

It should also be appreciated by those skilled in the art that the particular publishing system and method and other aspects of the teachings herein are but examples of the present invention. Thus, they do not limit the scope or variety of applications that the present invention may be suitably implemented. For example, various forms of creative content may be included in the book in addition to textual and graphical content such as audio files for storage and playback by said book, video data files, and web pages.

Therefore, it should be understood that the foregoing description is only illustrative of a present implementation of the teachings herein. Various alternatives and modification may be devised by those skilled in the art without departing from the present invention. Accordingly, the present invention is intended to embrace all such alternatives, modifications, and variances.

What is claimed is:

1. A method of publishing a book, said method comprising:
obtaining creative content for inclusion in said book;
disposing at least a portion of a representation of said creative content on an adhesive label, a substance, a layout, and an extent of said at least a portion of said creative content disposed on said adhesive label being fully customizable;
affixing said adhesive label having at least a portion of said representation of said creative content disposed thereon to at least a portion of a page comprising said book, wherein said obtaining, said disposing, and said affixing are performed under the direct control of a user.

2. The method of claim 1, wherein said creative content is obtained from the group consisting of a text file, a graphics file, a video file, a web page, an audio file, a user, and any combinations thereof.

3. The method of claim 1, further comprising disposing a clear protective covering over said adhesive label affixed to at least a portion of said page, wherein said at least a portion of said creative content disposed on said label is visible through said protective covering.

4. The method of claim 3, wherein said protective covering matingly conforms at least to said adhesive label.

5. The method of claim 1, further comprising customizing at least said substance, said layout, and said extent of said at least a portion of said creative content disposed on said adhesive label, according to a user's preference.

6. The method of claim 5, wherein said customizing is accomplished using a software module compatible with said creative content obtained for inclusion in said book.

7. The method of claim 1, wherein said book has, in total, a plurality of said adhesive labels affixed to a plurality of said pages of said book.

8. The method of claim 1, wherein said book comprises a board book having a plurality of pages of a rigid and durable pressed paper.

9. The method of claim 1, wherein said book published thereby is a fully personalized and completely customized story.
comprises a board book having a plurality of pages of a rigid and durable pressed paper.

10. A system for publishing a book, said system comprising:
an input device for obtaining creative content for inclusion in said book;
a processor for controlling the disposing of at least a portion of a representation of said creative content on an adhesive label, a substance, a layout, and an extent of said at least a portion of said creative content disposed on said adhesive label being fully customizable;
an output device for performing said disposing;
a book being a page for affixing said adhesive label with at least a portion of said representation of said creative content disposed thereon to at least a portion of said page, wherein said obtaining, said disposing, and said affixing are performed under the direct control of said user.

11. The system of claim 10, wherein said input device obtains said creative content from the group consisting of a text file, a graphics file, a video file, a web page, an audio file, a user, and any combinations thereof.

12. The system of claim 10, wherein said input device is selected from a group consisting of a mouse, a memory media reader, a memory storage device, a digital camera, a microphone, an optical scanner, and any combinations thereof.

13. The system of claim 10, wherein said output device or said user disposes a clear protective covering over said adhesive label affixed to at least a portion of said page, wherein said at least a portion of said creative content disposed on said label is visible through said protective covering.

14. The system of claim 13, wherein said protective covering matingly conforms to at least said adhesive label.

15. The system of claim 10, wherein said user customizes at least said substance, said layout, and said extent of said at least a portion of said creative content disposed on said adhesive label, according to at least one of said user's preferences.

16. The system of claim 15, wherein said customizing is accomplished with the aid of a software module compatible with said creative content obtained for inclusion in said book.

17. The system of claim 10, wherein said book published using said system has, in total, a plurality of said adhesive labels affixed to a plurality of said pages of said book.

18. The system of claim 10, further comprising a audio input device and an audio output device for the recording and playback of audio, respectively.

19. The system of claim 10, wherein said book comprises a board book having a plurality of pages of a rigid and durable pressed paper.

20. A system for publishing a book, said system comprising:
an input device for obtaining creative content for inclusion in said book;
a processor for controlling the disposing of at least a portion of a representation of said creative content on an adhesive label, a substance, a layout, and an extent of said at least a portion of said creative content disposed on said adhesive label being fully customizable;
an output device for performing said disposing;
a book being a page for affixing said adhesive label with at least a portion of said representation of said creative content disposed thereon to at least a portion of said page, wherein said obtaining, said disposing, and said affixing are performed under the direct control of said user, and said book includes a fully personalized and completely customized story.
